(19) United States
(12) Patent Application Publication
(10) Pub. No.: US 2025/0317930 A1
(43) Pub. Date: Oct. 9, 2025

(54) FLEXIBLE MONITORING OPERATION COMMENCEMENT TIME CONFIGURATION

(71) Applicant: QUALCOMM Incorporated, San Diego, CA (US)

(72) Inventors: Huilin XU, Temecula, CA (US); Le LIU, San Jose, CA (US); Mostafa KHOSHNEVISAN, San Diego, CA (US); Gabi SARKIS, San Diego, CA (US); Jing SUN, San Diego, CA (US); Kangqi LIU, San Diego, CA (US); Weimin DUAN, San Diego, CA (US)

(21) Appl. No.: 18/625,782

(22) Filed: Apr. 3, 2024

(51) Int. Cl. H04W 72/20; H04W 72/12

(52) U.S. Cl. CPC H04W 72/20; H04W 72/12

(57) ABSTRACT

Methods, systems, and devices for wireless communications are described. A user equipment (UE) may perform a monitoring operation at a commencement time that is calculated based on an ending time of a temporally last resources of one or more resources for one or more shared channel communications. The monitoring operation may include resuming physical downlink control channel (PDCCH) monitoring, switching active bandwidth parts (BWPs) at the UE, or continuing to perform shared channel communications via a same BWP after the commencement time. The UE may receive one or more indications, and the UE may calculate the commencement time from the ending time based on one or more indications. The one or more indications may include a quantity of slots to be subtracted from the ending time, one or more BWPs for use in different durations, and a timer value for summing with the ending time.

### FIELD OF TECHNOLOGY

The following relates to wireless communications, including flexible monitoring operation commencement time configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support flexible monitoring operation commencement time configuration. For example, the described techniques provide for a user equipment (UE) to receive control signaling indicating one or more resources scheduled for one or more shared channel communications, perform the one or more shared channel communications, and perform a monitoring operation at a commencement time that the UE calculates based on an ending time of a temporally last resources of the one or more resources. In some cases, the monitoring operation may include resuming physical downlink control channel (PDCCH) monitoring, switching active bandwidth parts (BWPs) at the UE, continuing to perform shared channel communications via a same BWP after the commencement time, or any combination thereof.

In some cases, the UE may receive one or more indications via the control signaling, via radio resource control (RRC) signaling, or both, and the UE may calculate the commencement time from the ending time based on one or more indications. For example, the one or more indications may include a quantity of slots (e.g., a scheduling offset, another quantity of slots). The UE may calculate the commencement time to be the ending time minus the quantity of slots, and the UE may resume PDCCH monitoring at the commencement time. Additionally, or alternatively, the one or more indications may include indications for the UE of a BWP for performing the one or more shared channel communications, a BWP for use after the commencement time, or both. Additionally, or alternatively, the one or more indications may include a timer value. The UE may calculate the commencement time to be the ending time plus the timer value, where the UE may switch from the BWP associated with the shared channel communications to another BWP at the commencement time. In some cases, the UE may calculate more than one commencement time, for example, associated with PDCCH skipping and BWP switching, respectively. Accordingly, the UE may perform both one or more monitoring operations at one or more respecting commencement times each calculated from a single ending time associated with the control signaling.

A method for wireless communications by a user equipment (UE) is described. The method may include receiving, via a control channel, control signaling indicating one or more scheduled resources for one or more shared channel communications, performing the one or more shared channel communications within the one or more scheduled resources in accordance with the control signaling, and performing a monitoring operation triggered by the control signaling, the monitoring operation starting at a commencement time calculated from an ending time of a temporally last resource of the one or more scheduled resources indicated by the control signaling.

A UE for wireless communications is described. The UE may include one or more memories storing processor executable code, and one or more processors coupled with the one or more memories. The one or more processors may individually or collectively be operable to execute the code to cause the UE to receive, via a control channel, control signaling indicating one or more scheduled resources for one or more shared channel communications, perform the one or more shared channel communications within the one or more scheduled resources in accordance with the control signaling, and perform a monitoring operation triggered by the control signaling, the monitoring operation starting at a commencement time calculated from an ending time of a temporally last resource of the one or more scheduled resources indicated by the control signaling.

Another UE for wireless communications is described. The UE may include means for receiving, via a control channel, control signaling indicating one or more scheduled resources for one or more shared channel communications, means for performing the one or more shared channel communications within the one or more scheduled resources in accordance with the control signaling, and means for performing a monitoring operation triggered by the control signaling, the monitoring operation starting at a commencement time calculated from an ending time of a temporally last resource of the one or more scheduled resources indicated by the control signaling.

A non-transitory computer-readable medium storing code for wireless communications is described. The code may include instructions executable by one or more processors to receive, via a control channel, control signaling indicating one or more scheduled resources for one or more shared channel communications, perform the one or more shared channel communications within the one or more scheduled resources in accordance with the control signaling, and perform a monitoring operation triggered by the control signaling, the monitoring operation starting at a commencement time calculated from an ending time of a temporally last resource of the one or more scheduled resources indicated by the control signaling.

In some examples of the method, UEs, and non-transitory computer-readable medium described herein, performing the monitoring operation may include operations, features, means, or instructions for resuming, after one or more skipped control signal monitoring occasions, a monitoring of control signal monitoring occasions on the control channel.

In some examples of the method, UEs, and non-transitory computer-readable medium described herein, the one or more skipped control signal monitoring occasions may be determined based on a communication direction of the one or more scheduled resources indicated by the control signaling.

In some examples of the method, UEs, and non-transitory computer-readable medium described herein, receiving the control signaling may include operations, features, means, or instructions for receiving a field including one or more bits, where the commencement time may be calculated from the ending time of the temporally last resource based on a value of the one or more bits.

In some examples of the method, UEs, and non-transitory computer-readable medium described herein, the field includes a control channel monitoring duration field, a dedicated field, or both.

Some examples of the method, UEs, and non-transitory computer-readable medium described herein may further include operations, features, means, or instructions for calculating the commencement time from the ending time of the temporally last resource by subtracting a quantity of slots from the ending time of the temporally last resource.

In some examples of the method, UEs, and non-transitory computer-readable medium described herein, the quantity of slots includes a minimum scheduling offset associated with the UE.

In some examples of the method, UEs, and non-transitory computer-readable medium described herein, the quantity of slots includes a lesser quantity of slots between a minimum scheduling offset associated with the UE and a constant quantity of slots.

In some examples of the method, UEs, and non-transitory computer-readable medium described herein, performing the monitoring operation may include operations, features, means, or instructions for switching to a second BWP based on a BWP switching indication indicated in the control signaling.

In some examples of the method, UEs, and non-transitory computer-readable medium described herein, the BWP switching indication includes a dedicated field of the control signaling including one bit and a value of the one bit indicates that the UE may be to switch to the second BWP at the commencement time that may be calculated from the ending time.

In some examples of the method, UEs, and non-transitory computer-readable medium described herein, the BWP switching indication includes a first bandwidth indicator field that indicates the first BWP, and a second field indicates the second BWP.

Some examples of the method, UEs, and non-transitory computer-readable medium described herein may further include operations, features, means, or instructions for receiving an indication of a timer value, where the commencement time may be calculated by summing the ending time of the temporally last resource and the timer value.

Some examples of the method, UEs, and non-transitory computer-readable medium described herein may further include operations, features, means, or instructions for transmitting a NACK indication based on failing to receive a shared channel communication of the one or more shared channel communications, where the method further includes and increasing the timer value based on failing to receive a retransmission of the shared channel communication in response to the NACK indication prior to the commencement time.

In some examples of the method, UEs, and non-transitory computer-readable medium described herein, a field of the control signaling includes the indication of the timer value.

In some examples of the method, UEs, and non-transitory computer-readable medium described herein, receiving the indication of the timer value may include operations, features, means, or instructions for receiving RRC signaling including the indication of the timer value.

Some examples of the method, UEs, and non-transitory computer-readable medium described herein may further include operations, features, means, or instructions for summing the ending time of the temporally last resource and the timer value may be based on a communication direction of the one or more shared channel communications.

In some examples of the method, UEs, and non-transitory computer-readable medium described herein, the control signaling further indicates a first BWP for the one or more shared channel communications and the method, apparatuses, and non-transitory computer-readable medium may include further operations, features, means, or instructions for receiving second control signaling before the commencement time, where performing the monitoring operation includes and continuing, before switching to the second BWP, shared channel communications within the first BWP for an additional time period after the commencement time.

### BRIEF DESCRIPTION OF THE DRAWINGS

FIG. 1 shows an example of a wireless communications system that supports flexible monitoring operation commencement time configuration in accordance with one or more aspects of the present disclosure.

FIGS. 2 and 3 show examples of communications timing diagrams that supports flexible monitoring operation commencement time configuration in accordance with one or more aspects of the present disclosure.

FIG. 4 shows an example of a process flow that supports flexible monitoring operation commencement time configuration in accordance with one or more aspects of the present disclosure.

FIGS. 5 and 6 show block diagrams of devices that support flexible monitoring operation commencement time configuration in accordance with one or more aspects of the present disclosure.

FIG. 7 shows a block diagram of a communications manager that supports flexible monitoring operation commencement time configuration in accordance with one or more aspects of the present disclosure.

FIG. 8 shows a diagram of a system including a device that supports flexible monitoring operation commencement time configuration in accordance with one or more aspects of the present disclosure.

FIG. 9 shows a flowchart illustrating methods that support flexible monitoring operation commencement time configuration in accordance with one or more aspects of the present disclosure.

### DETAILED DESCRIPTION

In some wireless communications systems, a network entity may schedule resources for multiple shared channel communications (e.g., physical downlink shared channel (PDSCH) communications (e.g., PDSCHs), physical uplink shared channel (PUSCH) communications (e.g., PUSCHs)) with a user equipment (UE) via a control signal (e.g., one downlink control information (DCI) message (e.g., DCI)). In some cases, the control signal may indicate a duration after reception of the control signaling that the UE may skip monitoring of control signal monitoring occasions. For example, the UE may skip monitoring one or more resources associated with a physical downlink control channel (PDCCH) during the shared channel communications to save power at the UE. Such skipping may be known as PDCCH skipping. However, the duration for PDCCH skipping indicated by the control signal may be limited to a quantity of fixed PDCCH skipping duration lengths, which may cause the UE to either perform PDCCH skipping for a shorter duration than the shared channel communications (e.g., wasting power), or for a longer duration than the shared channel communications (e.g., reducing communications reliability).

Additionally, or alternatively, the control signaling may indicate a bandwidth part (BWP) for the UE to use for performing the shared channel communications. For example, the UE may receive the control signal in a first BWP associated with low power consumption (e.g., a narrow BWP), and may perform the shared channel communications in a second BWP associated with high power consumption as well as improved communications reliability. However, after performing the shared channel communications, the UE may wait until receiving another control signaling to switch back into the first BWP, which may use an increased amount of power at the UE. In the cases of PDCCH skipping and BWP switching, the UE may benefit from a dynamic indication for timing for when to perform the respective monitoring operation.

According to techniques described herein, a UE may receive control signaling indicating one or more resources scheduled for one or more shared channel communications, perform the one or more shared channel communications, and perform a monitoring operation at a commencement time that the UE calculates based on an ending time of a temporally last resources of the one or more resources. In some cases, the monitoring operation may include resuming PDCCH monitoring, switching active BWPs at the UE, or continuing to perform shared channel communications via a same BWP after the commencement time.

In some cases, the UE may receive one or more indications via the control signaling, via RRC signaling, or both, and the UE may calculate the commencement time from the ending time based on one or more indications. For example, the one or more indications may include a quantity of slots (e.g., a scheduling offset, another quantity of slots). The UE may calculate the commencement time to be the ending time minus the quantity of slots, and the UE may resume PDCCH monitoring at the commencement time. Additionally, or alternatively, the one or more indications may include indications for the UE of a BWP for performing the one or more shared channel communications, a BWP for use after the commencement time, or both. Additionally, or alternatively, the one or more indications may include a timer value. The UE may calculate the commencement time to be the ending time plus the timer value, where the UE may switch from the BWP associated with the shared channel communications to another BWP at the commencement time. In some cases, the UE may calculate more than one commencement time, for example, associated with PDCCH skipping and BWP switching, respectively. Accordingly, the UE may perform both one or more monitoring operations at one or more respecting commencement times each calculated from a single ending time associated with the control signaling.

Aspects of the disclosure are initially described in the context of wireless communications systems. Aspects of the disclosure are also described with respect to communications timing diagrams and process flows. Aspects of the disclosure are further illustrated by and described with reference to apparatus diagrams, system diagrams, and flowcharts that relate to flexible monitoring operation commencement time configuration.

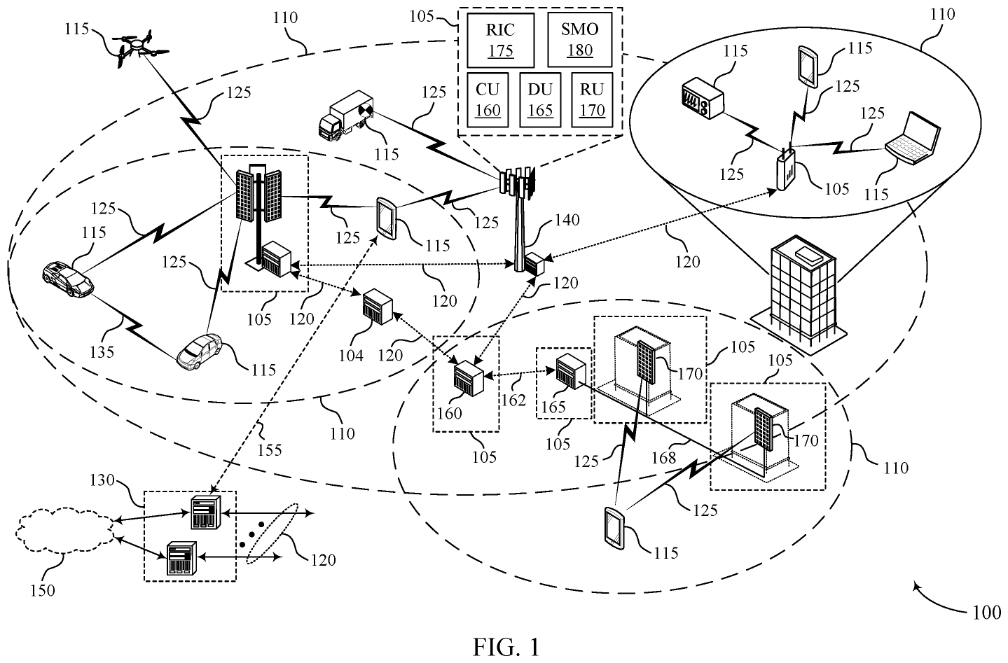

FIG. 1 shows an example of a wireless communications system 100 that supports flexible monitoring operation commencement time configuration in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, the wireless communications system 100 may support scheduling of multiple shared channel communications (e.g., transport blocks (TBs), communications) via one control signal (e.g., a DCI, a downlink or uplink scheduling DCI). For example, the control signal may schedule resources for multiple shared channel communications (e.g., PDSCHs or PUSCHs, respectively). In some cases, the resources for the multiple shared channel communication may be consecutive in time, or may be inconsecutive in time. For example, if a network device (e.g., a network entity 105, a UE 115) has a large chunk of data to transmit, the network device may lump scheduling information for shared channel communications carrying the large chunk of data into a single control signal, which may obviate issuing the transmission of individual control signals to schedule resources for each shared channel communication separately. For example, the wireless communications system 100 may schedule multiple communications via one control signal for transmission of large video packets that may occupy multiple slots (e.g., a variable quantity of slots).

In some cases, a UE 115 that receives a control signal that schedules resources for multiple communications may skip monitoring of one or more control signal monitoring occasions (e.g., PDCCH occasions). For example, the UE 115 may not monitor (e.g., continuously) a control channel for another scheduling control signal during at least a portion of resources scheduled for the multiple communications. Such skipping may be called PDCCH skipping, and PDCCH skipping used herein may refer to a UE refraining from monitoring (e.g., skipping monitoring of) any control signal monitoring occasion. In some cases, PDCCH skipping may allow the UE 115 to save power by not monitoring.

In some cases, the control signal that schedules resources for multiple communications may include a PDCCH skipping indication in a field of the DCI (e.g., a control channel monitoring duration field). In some cases, the PDCCH skipping indication may indicate a length of a skipping duration after the DCI, where the UE 115 may perform PDCCH skipping during the skipping duration. However, in some wireless communications systems, the PDCCH skipping indication may indicate a limited set of PDCCH skipping durations (e.g., a limited granularity of skipping durations, 3 options for lengths of a skipping duration). In such wireless communications systems, a network entity 105 may use RRC signaling to indicate (e.g., reconfigure) another set of skipping durations that the control signal may indicate via the PDCCH skipping indication. Such limited set of PDCCH skipping durations may lead to an increased usage of power at the UE, or less reliable communications at the UE, due to not monitoring PDCCHs for too long or too short of a duration compared to the multiple communications.

Additionally, or alternatively, in some wireless communications systems, a control signal may switch (e.g., dynamically) an active BWP for a UE 115. For example, the control signal may include a BWP indication field that indicates an active BWP for the UE 115 to use when performing the communications indicated by the control signal. For example, a downlink DCI may indicate an active downlink BWP for the UE 115, and an uplink DCI may indicate an active uplink BWP for the UE 115. In some cases, based on the BWP indication field, the UE 115 may perform the communications associated with the control signal in a wide BWP, which may use relatively high power at the UE 115 but may more effectively communicate the data, and the UE 115 may monitor for DCIs (e.g., data scheduling DCIs) in a narrow BWP, which may use relatively lower power at the UE 115.

However, in some wireless communication systems, once the UE 115 enters the wide BWP for the communications, the UE 115 may remain in the wide BWP until the UE 115 receives another control signal indicating the UE 115 to switch back to the narrow BWP. For some communications (e.g., bursty traffic with one dominant traffic flow), such BWP switching operations may not allow the UE 115 to switch to the narrow BWP directly after performing the communications, which may lead to excess power usage. In some other cases (e.g., multi-modal traffic), the UE 115 may continue to communicate via the wide BWP after performing communications for one traffic flow to communicate data for another traffic flow, where one or more DCIs scheduled the communications for the one traffic flow and for the other traffic flow. Thus, the UE may use more power based on a rigid system for switching BWPs.

According to techniques described herein, a UE 115 may receive control signaling indicating one or more resources scheduled for one or more shared channel communications, perform the one or more shared channel communications, and perform a monitoring operation at a commencement time that the UE 115 calculates based on an ending time of a temporally last resources of the one or more resources. In some cases, the monitoring operation may include resuming PDCCH monitoring, switching active BWPs at the UE 115, or continuing to perform shared channel communications via a same BWP after the commencement time.

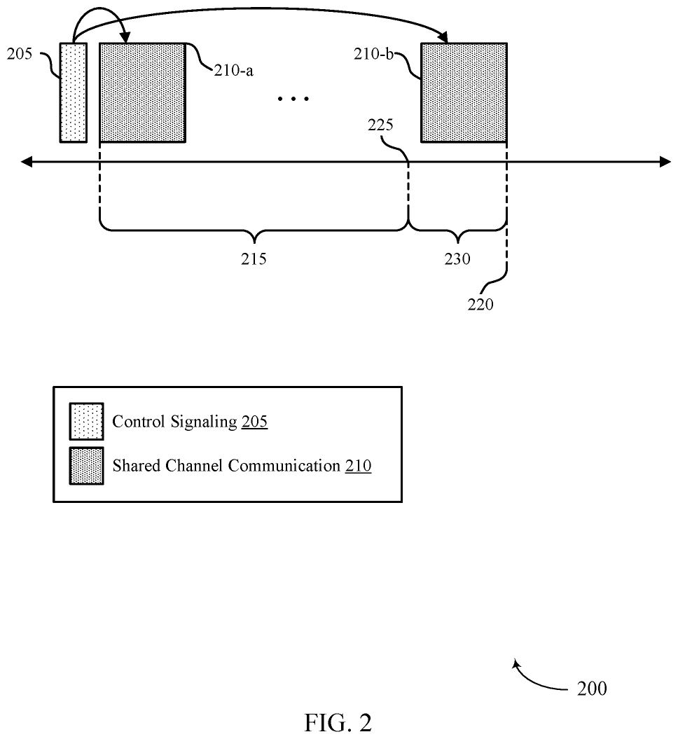

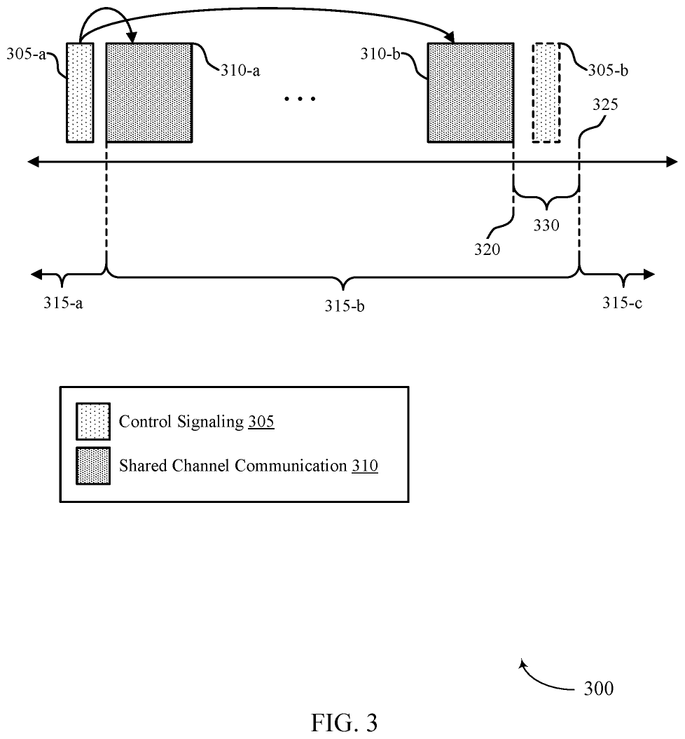

In some cases, the UE 115 may receive one or more indications via the control signaling, via RRC signaling, or both, and the UE may calculate the commencement time from the ending time based on one or more indications. For example, the one or more indications may include a quantity of slots (e.g., a scheduling offset, another quantity of slots, as described herein with respect to FIG. 2). The UE 115 may calculate the commencement time to be the ending time minus the quantity of slots, and the UE 115 may resume PDCCH monitoring at the commencement time. Additionally, or alternatively, the one or more indications may include indications for the UE 115 of a BWP for performing the one or more shared channel communications, a BWP for use after the commencement time, or both (e.g., as described herein with respect to FIG. 3). Additionally, or alternatively, the one or more indications may include a timer value (e.g., as described herein with respect to FIG. 3). The UE 115 may calculate the commencement time to be the ending time plus the timer value, where the UE 115 may switch from the BWP associated with the shared channel communications to another BWP at the commencement time. In some cases, the UE 115 may calculate more than one commencement time, for example, associated with PDCCH skipping and BWP switching, respectively (e.g., as described herein with respect to FIGS. 2 and 3, respectively). Accordingly, the UE 115 may perform both one or more monitoring operations at one or more respective commencement times each calculated from a single ending time associated with the control signaling.

As described herein, the monitoring operation may include one or more monitoring operations, including resuming (e.g., after the UE 115 may skip monitoring of one or more control signal monitoring occasions) PDCCH monitoring on a control channel (e.g., the control channel via which the UE 115 received the control signaling), switching BWPs based at least in part on a BWP switching indication indicated in the control signaling, and continuing (e.g., before switching to the narrow BWP) shared channel communications within a BWP for an additional time period after the commencement time (e.g., if the UE 115-a receives other control signaling before the commencement time). The following description of FIG. 2 may detail the monitoring operation of resuming PDCCH monitoring, and the description of FIG. 3 may detail the monitoring operations of BWP switching and continuing shared channel communications within a BWP, where a UE 115 may implement one or more of the examples at one or more commencement times. Additionally, each example may be associated with a different commencement time that is calculated from the ending time, such that the monitoring operation may be performed flexibly based on one or more shared channel communications.

FIG. 2 shows an example of a communications timing diagram 200 that supports flexible monitoring operation commencement time configuration in accordance with one or more aspects of the present disclosure. In some cases, aspects of the communications timing diagram 200 may implement or be implemented by aspects of FIG. 1. For example, the communications timing diagram may depict one or more communications (e.g., control signaling 205 such as DCIs or PDCCHs, shared channel communications 210 such as PDSCHs or PUSCHs) between a network entity 105 and a UE 115, as described herein with respect to FIG. 1. In some aspects, the UE 115 may receive control signaling 205 that schedules one or more shared channel communications (e.g., shared channel communications 210-a and 210-b), and the control signaling 205 may trigger the UE 115 to perform a monitoring operations at a commencement time 225 that is calculated from an ending time 220 of a temporally last resource scheduled by the control signaling 205. As described with respect to the communications timing diagram 200, the monitoring operation may include resuming a monitoring of control signal monitoring occasions.

In a first example of the monitoring operation (e.g., resuming control signal monitoring), the control signaling 205 may indicate a flexible termination of the PDCCH skipping for the UE 115-a. For example, the control signaling 205 (e.g., a multi-PDSCH or multi-PUSCH scheduling DCI) may indicate (e.g., explicitly or implicitly) a duration from a first scheduled resource (e.g., a first communication occasion, for the shared channel communication 210-a) to a last scheduled resource (e.g., for the shared channel communication 210-b) for the shared channel communications 210. In some cases, the termination of the last resource scheduled by the control signaling 205 may be called the ending time 220. In some cases, the UE 115 may skip monitoring (e.g., refrain from monitoring, stop monitoring) one or more control signaling monitoring occasions (e.g., PDCCHs) after receiving (e.g., immediately after receiving) the control signaling 205 until the commencement time 225, which the UE 115 may calculate based on the ending time 220. In some cases, such skipping may be referred to as PDCCH skipping, and may occur during the PDCCH skipping duration 215. The PDCCH skipping duration 215 may span from the beginning of the shared channel communication 210-a (e.g., or the end of the control signaling 205) to the commencement time 225. That is, the control signaling 205 may indicate the commencement time 225 for resuming monitoring of control signal monitoring occasions (e.g., terminating PDCCH skipping) based on the ending time 220. By this means, the PDCCH skipping may match (e.g., correspond to) the shared channel communications 210 (e.g., a bursty traffic pattern).

In some cases, a network entity 105 may configure one or more types of control signaling 205 to which the UE 115 may apply the indicated PDCCH skipping operation within the PDCCH skipping duration 215. For example, the network entity 105 may configure the UE 115 to perform the PDCCH skipping based on (e.g., according to) the control signaling 205. In some cases, if the control signaling 205 schedules downlink or uplink traffic (e.g., is a downlink or uplink scheduling DCI), the UE 115 may skip monitoring of control signaling 205 that schedules downlink or uplink traffic, respectively, during the PDCCH skipping duration 215. That is, the UE 115 may skip monitoring control signaling 205 that schedules shared channel communications 210 having a same communication direction as that scheduled by the control signaling 205. Additionally, or alternatively, the network entity 105 may configure the UE 115 to skip monitoring of control signaling 205 that schedules both (e.g., either) downlink or uplink traffic during the PDCCH skipping duration 215.

In some cases, the control signaling 205 may include a control channel monitoring duration field (e.g., a PDCCH monitoring duration field). In some wireless communications systems, the control channel monitoring duration field may indicate a quantity of slots (e.g., 4 slots, 8 slots) for the UE 115 to perform the PDCCH skipping (e.g., statically, not flexibly).

However, the UE 115 may perform flexible PDCCH skipping (e.g., utilize a flexible PDCCH skipping duration 215) based on a value of one or more bits within a field of the control signaling 205. For example, the control signaling 205 may include the control channel monitoring duration field, and value of the control channel monitoring duration field may indicate that the UE 115 is to calculate the commencement time 225 (e.g., and thus a length of the PDCCH skipping duration 215) based on the ending time 220. Additionally, or alternatively, the control signaling 205 may include a dedicated field (e.g., a new DCI field) that may indicate that the UE 115 is to calculate the commencement time 225 (e.g., and thus the length of the PDCCH skipping duration 215) based on the ending time 220. In some cases, the dedicated field may include one or more bits to provide the indication.

In some cases, the network entity 105 may configure the UE 115 with a scheduling offset (e.g., a minimum scheduling offset that the UE expects for control signaling, where the network entity 105 may ensure that an actual scheduling offset for control signaling (e.g., that is subsequent to the control signaling 205) is greater than or equal to the minimum scheduling offset). For example, if the control signaling 205 and the shared channel communications 210 are not within the same slot, the scheduling offset may allow the UE 115 to process one or more buffered control signaling samples (e.g., PDCCH samples) to detect the control signaling 205 in an offline manner. In some cases, such operations may reduce a power consumption at the UE 115 associated with receiving the control signaling 205.

In some cases, the commencement time 225 may be calculated from the ending time 220 based on the scheduling offset. For example, the commencement time 225 may occur previous to (e.g., before) the ending time 220 by a duration 230, which may be of a length of the scheduling offset. In some cases, the scheduling offset may be zero, such that the commencement time 225 and the ending time 220 are the same. Such calculation of the commencement time 225 may mitigate a delay in scheduling one or more shared channel communications from another control signaling after the control signaling 205 (e.g., such as control signaling 305-b, as described herein with respect to FIG. 3). In some cases, the UE 115 may determine that the commencement time 225 is the ending time even though the scheduling offset is nonzero.

Accordingly, the UE 115 may calculate the commencement time 225 (e.g., the end of the PDCCH skipping duration 215) by subtracting a quantity of slots (e.g., a time duration) from the ending time 220. In some cases, the quantity of slots may be the same as the scheduling offset. Additionally, or alternatively, the UE 115 may select the quantity of slots to be either the scheduling offset or a constant value of slots (e.g., 1 slot, 2 slots). For example, the UE 115 may select a minimum (e.g., a lesser quantity of slots) of the scheduling offset and the constant value to be the quantity of slots. Additionally, or alternatively, the UE 115 may select zero as the quantity of slots, such that the commencement time 225 is the same as the ending time 220.

Accordingly, the UE 115 may implement a flexible resuming of PDCCH monitoring after shared channel communications 210 associated with the control signaling 205 based on a length (e.g., in time) of the shared channel communications 210. In some aspects, such techniques may provide for increased power savings at the UE 115 due to increasing the PDCCH skipping duration 215 associated with the control signaling 205.

FIG. 3 shows an example of a communications timing diagram 300 that supports flexible monitoring operation commencement time configuration in accordance with one or more aspects of the present disclosure. Some aspects of the communications timing diagram 200 may implement or be implemented by aspects of FIGS. 1 and 2. For example, the communications timing diagram may depict one or more communications (e.g., control signaling 305 such as DCIs or PDCCHs, shared channel communications 210 such as PDSCHs or PUSCHs) between a network entity 105 and a UE 115, as described herein with respect to FIG. 1. Additionally, the communications timing diagram 300 may include control signaling 305-a, an ending time 320, and a commencement time 325, which may be, in some aspects, similar to the control signaling 205, the ending time 220, and commencement time 225, respectively, as described herein with respect to FIG. 2. In some aspects, the UE 115 may receive control signaling 305-a that schedules one or more shared channel communications (e.g., shared channel communications 310-a and 310-b), and the control signaling 305-a may trigger the UE 115 to perform a monitoring operation at the commencement time 325 that is calculated from an ending time 320 of a last resource scheduled by the control signaling 305-a. As described with respect to the communications timing diagram 300, the monitoring operation may include switching an active BWP at the UE 115, or continuing to use a same BWP as before the commencement time 325 for one or more communications (e.g., shared channel communications 310, control channel communications, other communications).

In some cases, the techniques described herein may enhance BWP switching operations at the UE 115 and enable the UE 115 to perform (e.g., flexibly) the shared channel communications 310 before or after the UE 115 switches from a first BWP to a second BWP. In some cases, the first BWP and the second BWP may each be one of a narrow BWP (e.g., for receiving the control signaling 205) or a wide BWP (e.g., associated with performing shared channel communications). The UE 115 may operate within the first BWP or the second BWP for each of a duration 315-a (e.g., which ends after the UE 115 receives the control signaling 305-a and before the shared channel communications 310 begin), a duration 315-b (which begins before the shared channel communications 310 and ends at the commencement time 325), and a duration 315-c (e.g., which begins at the commencement time 325). Although the communications timing diagram 300 depicts the control signaling 305-a scheduling multiple shared channel communications 310, the control signaling 305-a may schedule one shared channel communication (e.g., shared channel communication 310-b). In some cases, the control signaling 305-a may indicate a BWP in which the UE 115 is to operate for one or more of the durations 315, the commencement time for the UE 115 to switch to another BWP (e.g., the narrow BWP), or both.

For example, the control signaling 305-a may indicate whether the shared channel communications 310 occur before or after the UE 115 switches from a first BWP (e.g., a narrow BWP, for monitoring for the control signaling 305-a) to a second BWP (e.g., a wide BWP). That is, the control signaling 305-a may indicate whether the UE 115 is to switch to the second BWP before the shared channel communications 310 or after the shared channel communications 310. In some cases, the control signaling 305-a may include a field with one bit to indicate whether the UE 115 switches to the second BWP before or after the shared channel communications 310 (e.g., where the second BWP may be indicated by a BWP indicator field in the control signaling 305-a). Additionally, or alternatively, the control signaling 305-a may include two fields (e.g., the BWP indicator field and another (e.g., dedicated) field).

If the control signaling 305-a includes the field with one bit to indicate whether the UE 115 switches to the second BWP before or after the shared channel communications 310, a “0” bit value of the one bit may indicate the UE 115 to switch to the second BWP after the shared channel communications 310, and the “1” bit value may indicate the UE 115 to switch to the second BWP before the shared channel communications 310. In some cases, the “1” bit value may be trivial if the BWP indicator field of the control signaling 305-a indicates the shared channel communications occur within a same BWP as is used in the durations 315-a (e.g., a current active BWP), since the UE 115 may not switch BWPs.

If the control signaling 305-a includes two fields each indicating a BWP for a respective duration 315 (e.g., the durations 315-b and 315-c), the durations 315 may be associated with either of the first BWP and the second BWP. For example, a first field of the control signaling 305-a may indicate a BWP for the duration 315-b (e.g., where the shared channel communications occur), and a second field of the control signaling 305-a may indicate a BWP for the duration 315-c (e.g., for the UE 115 to switch to after the shared channel communication 310-b, or at the commencement time 325). In some cases, a BWP for duration 315-a may be the same or different from a BWP for duration 315-b (e.g., indicated by the first field), and a BWP for the duration 315-b may be the same or different from a BWP for the duration 315-c (e.g., indicated by second field).

In some cases, the control signaling 305-a may indicate a length of the duration 315-b based on the ending time 320. For example, the control signaling 305-a may include an explicit indication of the length of the duration 315-b (e.g., via a timer value, as described herein), or may implicitly indicate the length of the duration 315-b, for example by indicating that the commencement time 325 is calculated from the ending time 320, or the control signaling 305-a may indicate both.

For example, the control signaling 305-a may indicate a timer value for the UE 115 to stay in the wide BWP after the ending time (e.g., before it switches to another BWP, the narrow BWP). That is, the timer value may indicate a length of the duration 330, which may be a duration between the ending time and the commencement time. Thus, a timer with the timer value may start at the ending time 320, and the commencement time 325 may occur at the expiration of the timer.

In some cases, the control signaling 305-a may indicate the timer value explicitly via a field. A network entity 105 may configure the UE 115 with a mapping of the timer value indicated in the field to a length of the duration 330. In some cases, the mapping may be based on a communications direction associated with the shared channel communications 310. For example, the mapping may indicate that a same value of the field corresponds to different lengths of the duration 330 based on whether the shared channel communications 310 are uplink or downlink.

Additionally, or alternatively, the network entity 105 may indicate the timer value to the UE 115 via RRC signaling. For example, the RRC signaling may indicate a quantity of slots (e.g., 1 or 2 slots) for the timer value (e.g., and thus the length of the duration 330). In some cases, the RRC signaling may indicate different quantities of slots for the timer value based on whether the shared channel communications are uplink or downlink.

Irrespective of how the UE 115 receives the indication of the timer value, the indication may include one or more special timer values. For example, the indication may include an “infinite” timer value, which may be a special timer value that indicates that the UE 115 is to stay in the BWP of duration 315-b after the commencement time 325 (e.g., until another control signaling 305 (e.g., the control signaling 305-b) indicates otherwise). Additionally, or alternatively, the indication may include a “zero” timer value, which may be a special timer value that indicates that the UE 115 is to switch to the BWP for duration 315-c at the ending time 320 (e.g., the length of the duration 330 is zero slots, the commencement time 325 and the ending time 320 are the same).

As described herein, the control signaling 305-a may include the field of one bit for indicating whether the UE 115 is to switch to a second BWP before or after the shared channel communications 310. In such a case, if the UE 115 switches to the second BWP before the shared channel communication 310, the UE 115 may return to the first BWP after an expiration of the timer value (e.g., at the commencement time 325).

In some cases, the UE 115 may use the duration 330 (e.g., indicated by the timer value) for performing additional shared channel communications 310 (e.g., new data transmissions) or for communicating retransmissions of one or more shared channel communications 310 that failed. If the UE 115 receives an indication of two timer values (e.g., one associated with uplink shared communications and one associated with downlink shared communications), the timer value associated with shared channel communications 310 in uplink may be longer than a timer value associated with shared channel communication 310 in downlink. Thusly, the duration 330 may allow more time for the UE 115 to determine whether any uplink shared channel communication has failed. Additionally, if the shared channel communications 310 are of a same packet scheduled by the control signaling 305-a, the shared channel communications 310 may share a same delay deadline, and thus retransmissions for multiple shared channel communications 310 that are failed may be communicated in any order.

If the UE 115 receives the control signaling 305-b (e.g., a second DCI) within the duration 330 (e.g., before the expiration of the timer value), the monitoring operation may include continuing shared channel communications 310 after the commencement time 225 in a same BWP as duration 315-b (e.g., and thus duration 330). That is, based on receiving the control signaling 305-b within the duration 330, the UE 115 may cancel a BWP switching (e.g., indicated by the control signaling 305-a) at the commencement time 325. Additionally, or alternatively, the UE 115 may reset the timer value begin at an ending time associated with the control signaling 305-b (e.g., not shown) based on receiving the control signaling 305-b. The UE 115 may also perform (e.g., at the commencement time 325) one or more other shared channel communications associated with the control signaling 305-b (e.g., not shown) in the BWP of duration 315-b. In some cases, the control signaling 305-b may schedule one or more shared channel communications for a later duration (e.g., different from the one or more shared channel communications of the duration 315-b), or may schedule retransmissions of the one or more shared channel communications 310 indicated by the control signaling 305-a, or both.

If the shared channel communications 310 include one or more downlink communications (e.g., PDSCHs) from a network entity 105, the UE 115 may report a negative acknowledgement (NACK) to the network entity 105 associated with a shared channel communication 310 that is failed (e.g., that the UE 115 did not decode). In some cases, the UE 115 may wait for a retransmission from the network of the shared channel communication 310, and may increase the timer value (e.g., extend the duration 330, delay the commencement time 325) based on waiting for the retransmission. For example, when the timer value expires (e.g., at commencement time 325), if the UE 115 has not received retransmissions for shared channel communications 310 that failed and for which the UE 115 reported NACKs to the network entity 105, the UE 115 may increase the timer value (e.g., thus delaying the commencement time 325). In some cases, the UE 115 may switch to the BWP associated with the duration 315-c (e.g., according to the control signaling 305-a) at expiration of the increased timer value (e.g., if the UE 115 does not receive the control signaling 305-b during the increased timer value).

The remaining portion of the detailed description of FIG. 3 may describe example scenarios for utilization of the techniques described herein with respect to FIGS. 2, 3, and 4.

In a first example scenario, a network entity 105 may transmit the control signaling 305-a to a UE 115, where the control signaling 305-a may include a field of one bit (e.g., as described herein) that may indicate to the UE 115 to switch from a first BWP (e.g., a narrow BWP) to a second BWP (e.g., a wide bandwidth part) before performing one or more shared channel communications 310 indicated by the control signaling 305-a. The one bit may also indicate (e.g., implicitly) for the UE 115 to return to the first BWP to monitor scheduling information at a commencement time 325 that is based on the ending time 320 (e.g., as described herein). The UE 115 may receive an indication of a timer value (e.g., via the control signaling 305-a, via RRC signaling), which may indicate a length of the duration 330 to be 2 slots. In some cases, the UE 115 may also skip PDCCH monitoring during a PDCCH skipping duration 215 based on the control signaling 305-a (e.g., as described herein with respect to FIG. 2).

The timer value (e.g., in this case, of 2 slots) may be for the UE 115 to receive additional shared channel communications (e.g., retransmissions) or a control signaling 305-b (e.g., another DCI, a retransmission scheduling DCI) within the BWP where the shared channel communications 310 occurred. If the UE 115 does not receive the control signaling 305-b within the duration 330, if the UE 115 does not transmit a NACK associated with the shared channel communications 310, if the UE 115 does not receive any requested retransmission of the shared channel communications 310 before the commencement time 325 (e.g., at the expiration of the timer value), or any combination thereof, the UE 115 may switch to the first BWP at the commencement time 325 (e.g., as indicated by the control signaling 305-a). Alternatively, if the UE 115 receives the control signaling 305-b within the duration 330, the UE 115 may cancel the BWP switching at the commencement time 325 indicated by the control signaling 305-a, and may remain operating in the second BWP (e.g., for the shared channel communications 310) past the commencement time 325 to perform one or more shared channel communications associated with the control signaling 305-b (e.g., not shown).

In a second example scenario, the UE 115 may be operating within a first BWP (e.g., the wide BWP) within the duration 315-a, and may have completed communication of or partially communicated data for a first traffic flow (e.g., associated with a previous control signaling that is not shown in FIG. 3) within the duration 315-a. The UE 115 may receive the control signaling 305-a, which may indicate one or more shared channel communications 310 that are associated with a second traffic flow, remaining shared channel communications for the first traffic flow, or both. In this case, one or more bits (e.g., as described herein) in one or more fields (e.g., BWP switching fields, dedicated fields) of the control signaling 305-a may indicate that the UE is to remain in the first BWP (e.g., associated with the duration 315-a) in the duration 315-b to perform the shared channel communications 310 associated with the control signaling 305-a, and switch to a second BPW (e.g., the narrow BWP) after the shared channel communications 310. Similar to the first example scenario, the UE 115 may receive a timer value which may indicate a length of the duration 330, and the UE 115 may skip PDCCH monitoring within the PDCCH skipping duration 215.

As with the first example scenario, if the UE 115 does not receive the control signaling 305-b within the duration 330, if the UE 115 does not transmit a NACK associated with the shared channel communications 310, if the UE 115 does not receive any requested retransmission of the shared channel communications 310 before the commencement time 325, or any combination thereof, the UE 115 may switch to the first BWP at the commencement time 325 (e.g., as triggered by the control signaling 305-a). Alternatively, if the UE 115 receives the control signaling 305-b within the duration 330, the UE 115 may cancel the BWP switching triggered for the commencement time 325, and may remain operating in the second BWP (e.g., for the shared channel communications 310) past the commencement time.

By implementing the techniques described herein, the UE 115 may reduce a power usage at the UE 115 associated with performing shared channel communications 310. For example, the UE 115 may switch to a narrow BWP at the commencement time 225, which may be sooner after the shared channel communications than otherwise, and may save power at the UE 115.

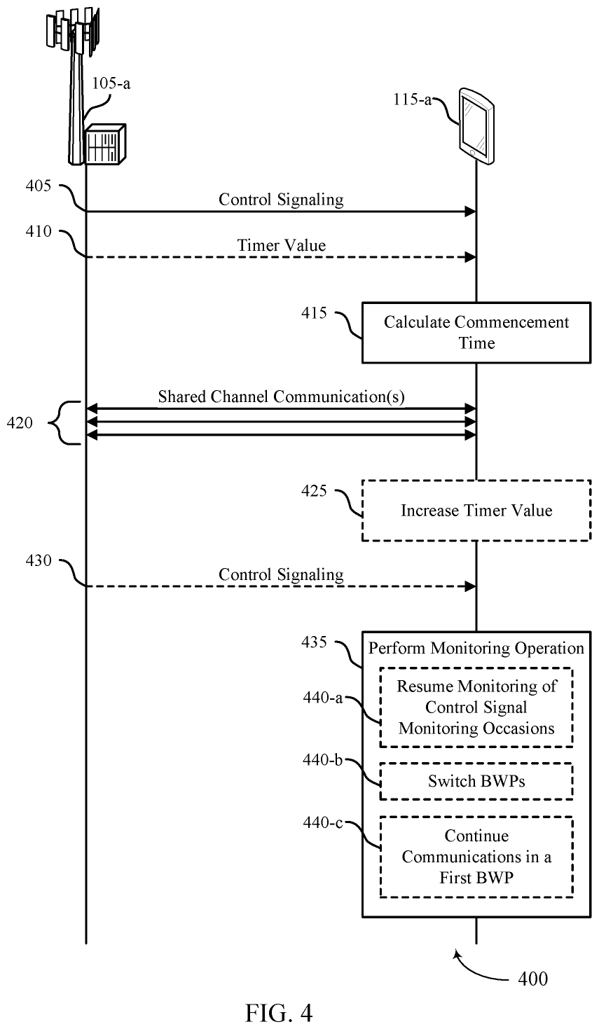

FIG. 4 shows an example of a process flow 400 that supports flexible monitoring operation commencement time configuration in accordance with one or more aspects of the present disclosure. In some cases, aspects of the process flow 400 may implement or be implemented by aspects of FIGS. 1 and 2. For example, the process flow 400 may include a UE 115-a and a network entity 105-a, which may be examples of the UEs 115 and the network entities 105 as described herein with respect to FIGS. 1 and 2. In some aspects, the UE 115-a may receive control signaling indicating one or more scheduled resources for shared channel communications, perform the shared channel communications, and perform a monitoring operation based on the control signaling at a commencement time calculated based on an ending time of a last scheduled resource.

In the following description of process flow 400, the operations may be performed in a different order than the order shown, or other operations may be added or removed from the process flow 400. For example, some operations may also be left out of process flow 400, may be performed in different orders or at different times, or other operations may be added to process flow 400. Although the UE 115-a and the network entity 105-a are shown performing the operations of process flow 400, some aspects of some operations may also be performed by one or more other wireless devices or network devices.

At 405, the UE 115-a may receive, via a control channel between the network entity 105-a and the UE 115-a, control signaling that may indicate one or more scheduled resources for one or more shared channel communications. For example, the control signaling may include one or more DCIs. In some cases, the control signaling may include one or more fields. For example, the control signaling may include a field that indicates (e.g., includes) one or more bits of information associated with a monitoring operation (e.g., the monitoring operation described herein at 435). The one or more bits may be further described at 415. In some cases, the field may be a control channel monitoring duration field (e.g., a reused legacy field), a dedicated field (e.g., a new field in a DCI, a field dedicated to performing the monitoring operation), or both. Additionally, or alternatively, the control signaling may indicate a BWP switching indication, which may be further described at 440-b. Additionally, or alternatively, the control signaling may indicate a first BWP within which the UE 115-a may perform the one or more shared channel communications (e.g., further described herein at 440-b).

In some cases, at 410, the UE 115-a may receive an indication of a timer value. In some cases, the UE 115-a may use the timer value in calculating a commencement time as described herein at 415. In some cases, a field of the control signaling may include the indication of the timer value. Additionally, or alternatively, the UE 115-a may receive RRC signaling that includes the indication of the timer value.

At 415, the UE 115-a may calculate the commencement time, which may be a time at which the UE 115-a performs the monitoring operation (e.g., that is triggered by the control signaling at 405). In some cases, the UE 115-a may calculate the commencement time from (e.g., based on, using) an ending time of a temporally last resource of the one or more scheduled resources. In some cases, the UE 115-a may calculate the commencement time of the monitoring operation based on a value of the one or more bits received in the control signaling at 405. For example, the one or more bits may indicate that the UE 115-a is to calculate the commencement time from the ending time (e.g., as opposed to a different calculation or approach).

Additionally, or alternatively, the UE 115-a may calculate the commencement time from the ending time of the temporally last resource by subtracting a quantity of slots from the ending time of the temporally last resource. For example, the quantity of slots may include a minimum scheduling offset associated with the UE 115-a. Additionally, or alternatively, the UE 115-a may perform a comparison between the quantity of slots of a minimum scheduling offset and a constant quantity of slots (e.g., 1 slot, 2 slots, 3 slots), and the UE 115-a may use a lesser quantity of slots between the minimum scheduling offset associated with the UE and the constant quantity of slots as the quantity of slots.

Additionally, or alternatively, the UE 115-a may use the timer value in calculating the commencement time. For example, the UE 115-a may calculate the commencement time by summing the ending time of the temporally last resource and the timer value. That is, the UE 115-a may determine that the commencement time is later than the ending time by the timer value (e.g., a quantity of slots, a quantity of time). In some cases, summing the ending time of the temporally last resource and the timer value may be based on a communication direction (e.g., uplink, downlink, indicated slot format) of the one or more shared channel communications. For example, the UE 115-a may receive a first timer value to sum with a temporally last resource of resources scheduled for uplink shared channel communications, and the UE 115-a may receive a second timer value to sum with a temporally last resource of resources scheduled for downlink shared channel communications, where the first timer value and the second timer value may be different.

At 420, the UE 115-a may perform the one or more shared channel communications within the one or more scheduled resources in accordance with the control signaling. Additionally, or alternatively, the UE 115-a may perform the one or more shared channel communications within the first BWP indicated in the control signaling. In some cases, performing the one or more shared channel communications may include transmitting a negative acknowledgement indication (e.g., a NACK). For example, the UE 115-a may transmit a negative acknowledgment indication to the network entity 105-a based on failing to receive a shared channel communication of the one or more shared channel communications.

In some cases, at 425, the UE 115-a may increasing the timer value (e.g., which may further delay the commencement time). For example, if the UE 115-a fails to receive a retransmission of a shared channel communication (e.g., in response to transmitting the negative acknowledgement indication at 420) prior to the commencement time, the UE 115-a may increase the timer value, for example, to allow more time for receiving the retransmission before performing the monitoring operation.

In some cases, at 430, the UE 115-a may receive a second control signaling (e.g., before the calculated commencement time). In some cases, the second control signaling may include one or more second scheduled resources for one or more second shared channel communications, another timer value, one or more other bits, or any combination thereof, as described herein.

At 435, the UE 115-a may perform a monitoring operation that is triggered by the control signaling (e.g., at 405, triggered because the UE 115-a received the control signaling at 405, based on information indicated by the control signaling received at 405). In some cases, the monitoring operation may start (e.g., be initiated, happen, occur) at the commencement time that the UE 115-a calculated from the ending time of the temporally last resource of the one or more scheduled resources indicated by the control signaling. In some cases, the monitoring operation may include one or more operations, described herein with respect to at least 440-a, 440-b, and 440-c.

In some cases, at 440-a, to perform the monitoring operation, the UE 115-a may resume a monitoring of control signal monitoring occasions on the control channel between the UE 115-a and the network entity 105-a. For example, the UE 115-a may skip a monitoring of one or more control signal monitoring occasions based on the control signaling (e.g., based on an indication in the control signaling to skip monitoring), where the one or more skipped control signal monitoring occasions occur within a duration that may extend from reception of the control signaling at 405 to the commencements time. At 440-a (e.g., at the calculated commencement time), the UE 115-a may resume monitoring the control signal monitoring occasions.

In some cases, the one or more skipped control signal monitoring occasions may be skipped (e.g., determined) based at least in part on a communication direction of the one or more scheduled resources indicated by the control signaling at 405. For example, if the one or more scheduled resources are for uplink shared channel communications (e.g., PUSCHs), the UE 115-a may skip monitoring control signals that schedule uplink shared channel communications (e.g., uplink DCIs). Additionally, or alternatively, if the one or more scheduled resources are for downlink shared channel communications (e.g., PDSCHs), the UE 115-a may skip monitoring control signals that schedule downlink shared channel communications (e.g., downlink DCIs).

In some cases, at 440-b, to perform the monitoring operation, the UE 115-a may switch to a second BWP (e.g., monitoring via a second BWP) based on a BWP switching indication indicated in the control signaling received at 405. In some cases, the BWP switching indication may include a dedicated field (e.g., a new DCI field for the BWP switching indication) of the control signaling. For example, the BWP switching indication may include (e.g., indicate) one or more bits, where a value of the one or more bits may indicates that the UE 115-a is to switch to the second BWP at the calculated commencement time. Additionally, or alternatively, the BWP switching indication may include a first bandwidth indicator field (e.g., a dedicated field, a legacy field) that indicates the first BWP, and a second field (e.g., in the control signaling of 405, dedicated field, legacy field) may indicate the second BWP.

In some cases, at 440-c, to perform the monitoring operation, the UE 115-a may continue to perform communications (e.g., shared channel communications, control channel communications, other communications) in the first BWP (e.g., indicated by the control signaling). For example, if the UE 115-a receives the second control signaling at 430, the UE 115-a may continue to perform shared channel communications (e.g., associated with the second control signal, the one or more second shared channel communications) within the first BWP (e.g., indicated in the control signaling at 405) for an additional time period after the commencement time. For example, the second control signaling of 430 may indicate the one or more second scheduled resources for the one or more second shared channel communications, and the UE 115-a may (e.g., at the calculated commencement time) begin performing the one or more second shared channel communications. In some cases, the UE 115-a may calculate a second commencement time based on the second control signaling (e.g., as described herein with respect to the first control signaling) and an ending time of a temporally last second scheduled resource.

Accordingly, the UE 115-a may perform the monitoring operation in a more flexible way. This may allow the UE 115-a to reduce power usage in a more flexible way, for example, by skipping PDCCH monitoring until the commencement time, by switching to a second (e.g., smaller) BWP for monitoring at the commencement time, or both.

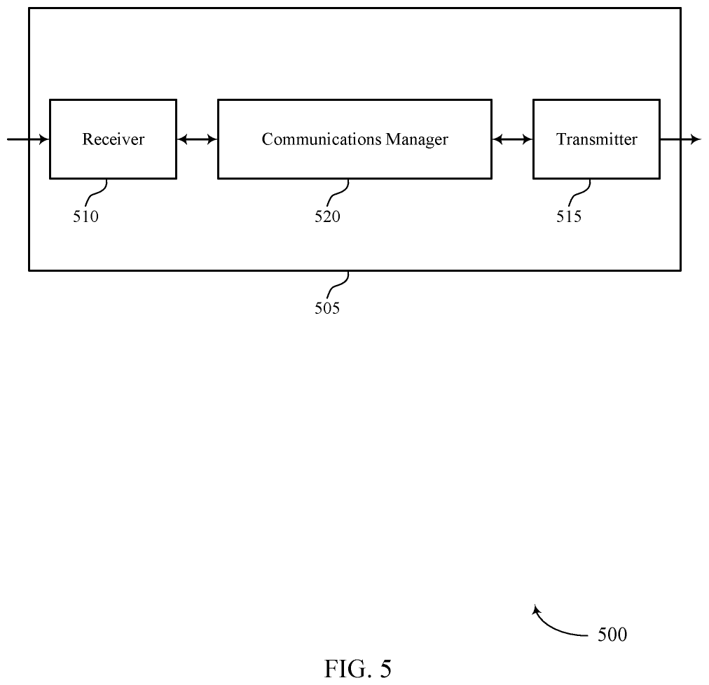

FIG. 5 shows a block diagram 500 of a device 505 that supports flexible monitoring operation commencement time configuration in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to flexible monitoring operation commencement time configuration). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to flexible monitoring operation commencement time configuration). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of flexible monitoring operation commencement time configuration as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, via a control channel, control signaling indicating one or more scheduled resources for one or more shared channel communications. The communications manager 520 is capable of, configured to, or operable to support a means for performing the one or more shared channel communications within the one or more scheduled resources in accordance with the control signaling. The communications manager 520 is capable of, configured to, or operable to support a means for performing a monitoring operation triggered by the control signaling, the monitoring operation starting at a commencement time calculated from an ending time of a temporally last resource of the one or more scheduled resources indicated by the control signaling.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and improved communications reliability. For example, a UE the implements the techniques described herein may switch to monitoring a limited BWP at the commencement time, which may utilize less energy. Additionally, or alternatively, the UE may return to monitoring control signaling monitoring occasions at the commencement time, which may save power during the shared channel communications and improve communication reliability due to returning to monitor the control signaling monitoring occasions.

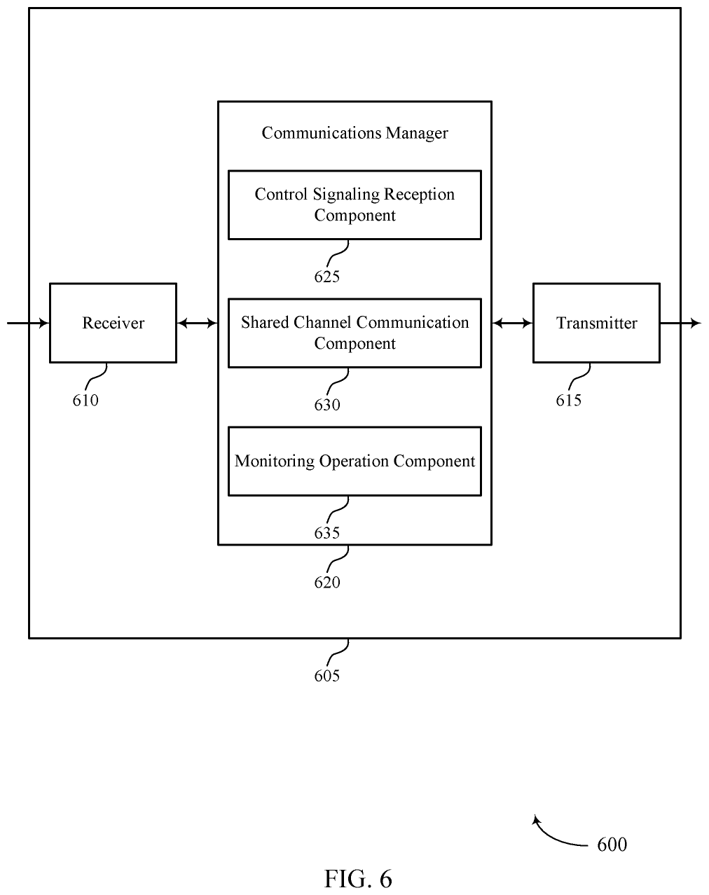

FIG. 6 shows a block diagram 600 of a device 605 that supports flexible monitoring operation commencement time configuration in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to flexible monitoring operation commencement time configuration). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to flexible monitoring operation commencement time configuration). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of flexible monitoring operation commencement time configuration as described herein. For example, the communications manager 620 may include a control signaling reception component 625, a shared channel communication component 630, a monitoring operation component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control signaling reception component 625 is capable of, configured to, or operable to support a means for receiving, via a control channel, control signaling indicating one or more scheduled resources for one or more shared channel communications. The shared channel communication component 630 is capable of, configured to, or operable to support a means for performing the one or more shared channel communications within the one or more scheduled resources in accordance with the control signaling. The monitoring operation component 635 is capable of, configured to, or operable to support a means for performing a monitoring operation triggered by the control signaling, the monitoring operation starting at a commencement time calculated from an ending time of a temporally last resource of the one or more scheduled resources indicated by the control signaling.

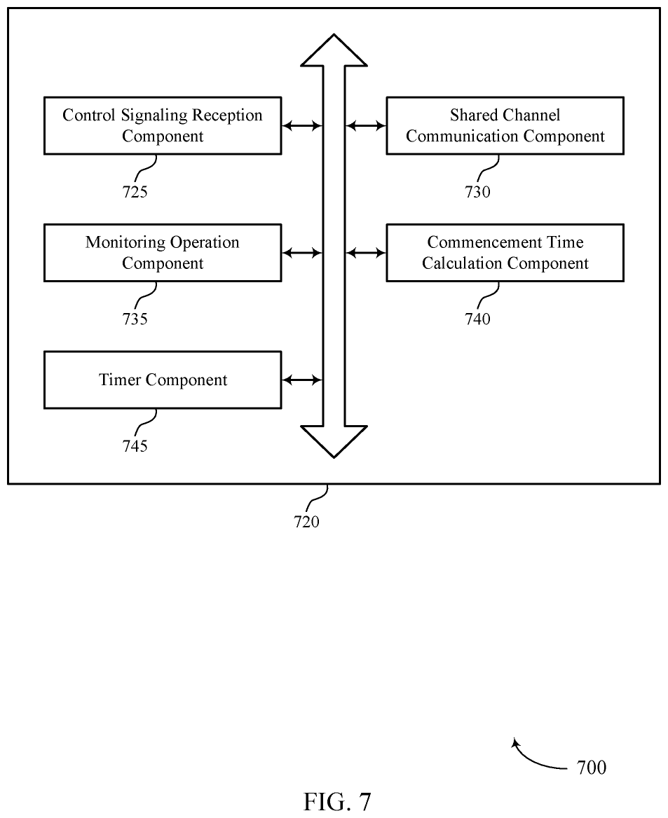

FIG. 7 shows a block diagram 700 of a communications manager 720 that supports flexible monitoring operation commencement time configuration in accordance with one or more aspects of the present disclosure. The communications manager 720 may be an example of aspects of a communications manager 520, a communications manager 620, or both, as described herein. The communications manager 720, or various components thereof, may be an example of means for performing various aspects of flexible monitoring operation commencement time configuration as described herein. For example, the communications manager 720 may include a control signaling reception component 725, a shared channel communication component 730, a monitoring operation component 735, a commencement time calculation component 740, a timer component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control signaling reception component 725 is capable of, configured to, or operable to support a means for receiving, via a control channel, control signaling indicating one or more scheduled resources for one or more shared channel communications. The shared channel communication component 730 is capable of, configured to, or operable to support a means for performing the one or more shared channel communications within the one or more scheduled resources in accordance with the control signaling. The monitoring operation component 735 is capable of, configured to, or operable to support a means for performing a monitoring operation triggered by the control signaling, the monitoring operation starting at a commencement time calculated from an ending time of a temporally last resource of the one or more scheduled resources indicated by the control signaling.

In some examples, to support performing the monitoring operation, the monitoring operation component 735 is capable of, configured to, or operable to support a means for resuming, after one or more skipped control signal monitoring occasions, a monitoring of control signal monitoring occasions on the control channel.

In some examples, the one or more skipped control signal monitoring occasions are determined based on a communication direction of the one or more scheduled resources indicated by the control signaling.

In some examples, to support receiving the control signaling, the control signaling reception component 725 is capable of, configured to, or operable to support a means for receiving a field including one or more bits, where the commencement time is calculated from the ending time of the temporally last resource based on a value of the one or more bits.

In some examples, the field includes a control channel monitoring duration field, a dedicated field, or both.

In some examples, the commencement time calculation component 740 is capable of, configured to, or operable to support a means for calculating the commencement time from the ending time of the temporally last resource by subtracting a quantity of slots from the ending time of the temporally last resource.

In some examples, the quantity of slots includes a minimum scheduling offset associated with the UE.

In some examples, the quantity of slots includes a lesser quantity of slots between a minimum scheduling offset associated with the UE and a constant quantity of slots.

In some examples, to support performing the monitoring operation, the monitoring operation component 735 is capable of, configured to, or operable to support a means for switching to a second BWP based on a BWP switching indication indicated in the control signaling.

In some examples, the BWP switching indication includes a dedicated field of the control signaling including one bit. In some examples, a value of the one bit indicates that the UE is to switch to the second BWP at the commencement time that is calculated from the ending time.

In some examples, the BWP switching indication includes a first bandwidth indicator field that indicates the first BWP, and a second field indicates the second BWP.

In some examples, the timer component 745 is capable of, configured to, or operable to support a means for receiving an indication of a timer value, where the commencement time is calculated by summing the ending time of the temporally last resource and the timer value.

In some examples, performing the one or more shared channel communications may include transmitting a negative acknowledgement indication based on failing to receive a shared channel communication of the one or more shared channel communications, where the method further includes increasing the timer value based at least in part on failing to receive a retransmission of the shared channel communication in response to the negative acknowledgement indication prior to the commencement time. In some examples, increasing the timer value based on failing to receive a retransmission of the shared channel communication in response to the negative acknowledgement indication prior to the commencement time.

In some examples, a field of the control signaling includes the indication of the timer value.

In some examples, to support receiving the indication of the timer value, the timer component 745 is capable of, configured to, or operable to support a means for receiving radio resource control signaling including the indication of the timer value.

In some examples, summing the ending time of the temporally last resource and the timer value is based on a communication direction of the one or more shared channel communications.

In some examples, the control signaling further indicates a first BWP for the one or more shared channel communications, and the control signaling reception component 725 is capable of, configured to, or operable to support a means for receiving second control signaling before the commencement time, where performing the monitoring operation includes continuing, before switching to the second bandwidth part, shared channel communications within the first bandwidth part for an additional time period after the commencement time. In some examples, the control signaling further indicates a first BWP for the one or more shared channel communications, and the shared channel communication component 730 is capable of, configured to, or operable to support a means for continuing, before switching to the second BWP, shared channel communications within the first BWP for an additional time period after the commencement time.

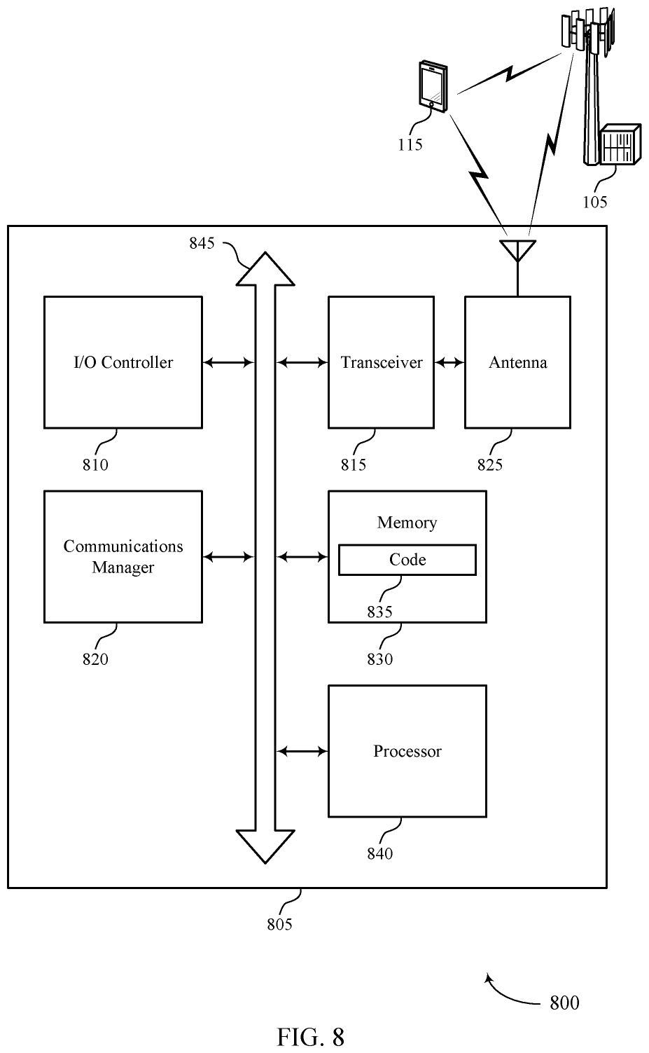

FIG. 8 shows a diagram of a system 800 including a device 805 that supports flexible monitoring operation commencement time configuration in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting flexible monitoring operation commencement time configuration). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, via a control channel, control signaling indicating one or more scheduled resources for one or more shared channel communications. The communications manager 820 is capable of, configured to, or operable to support a means for performing the one or more shared channel communications within the one or more scheduled resources in accordance with the control signaling. The communications manager 820 is capable of, configured to, or operable to support a means for performing a monitoring operation triggered by the control signaling, the monitoring operation starting at a commencement time calculated from an ending time of a temporally last resource of the one or more scheduled resources indicated by the control signaling.

By including or configuring the communications manager 820 in accordance with examples as described herein, the device 805 may support techniques for reduced power consumption and improved communications reliability. For example, a UE the implements the techniques described herein may switch to monitoring a limited BWP at the commencement time, which may utilize less energy. Additionally, or alternatively, the UE may return to monitoring control signaling monitoring occasions at the commencement time, which may save power during the shared channel communications and improve communication reliability due to returning to monitor the control signaling monitoring occasions.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of flexible monitoring operation commencement time configuration as described herein, or the at least one processor 840 and the at least one memory 830 may be otherwise configured to, individually or collectively, perform or support such operations.

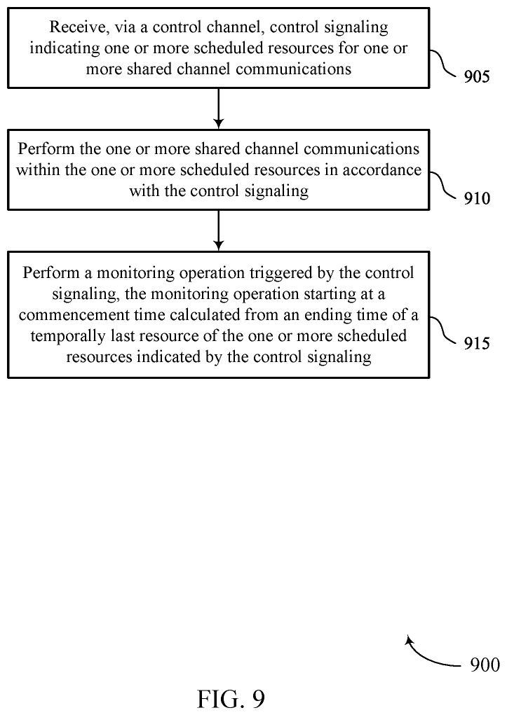

FIG. 9 shows a flowchart illustrating a method 900 that supports flexible monitoring operation commencement time configuration in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, via a control channel, control signaling indicating one or more scheduled resources for one or more shared channel communications. The operations of 905 may be performed in accordance with examples as disclosed herein. In some examples, aspects of the operations of 905 may be performed by a control signaling reception component 725 as described with reference to FIG. 7.

At 910, the method may include performing the one or more shared channel communications within the one or more scheduled resources in accordance with the control signaling. The operations of 910 may be performed in accordance with examples as disclosed herein. In some examples, aspects of the operations of 910 may be performed by a shared channel communication component 730 as described with reference to FIG. 7.

At 915, the method may include performing a monitoring operation triggered by the control signaling, the monitoring operation starting at a commencement time calculated from an ending time of a temporally last resource of the one or more scheduled resources indicated by the control signaling. The operations of 915 may be performed in accordance with examples as disclosed herein. In some examples, aspects of the operations of 915 may be performed by a monitoring operation component 735 as described with reference to FIG. 7.

The following provides an overview of aspects of the present disclosure:

Aspect 1: A method for wireless communications at a UE, comprising: receiving, via a control channel, control signaling indicating one or more scheduled resources for one or more shared channel communications; performing the one or more shared channel communications within the one or more scheduled resources in accordance with the control signaling; and performing a monitoring operation triggered by the control signaling, the monitoring operation starting at a commencement time calculated from an ending time of a temporally last resource of the one or more scheduled resources indicated by the control signaling.

Aspect 2: The method of aspect 1, wherein performing the monitoring operation comprises: resuming, after one or more skipped control signal monitoring occasions, a monitoring of control signal monitoring occasions on the control channel.

Aspect 3: The method of aspect 2, wherein the one or more skipped control signal monitoring occasions are determined based at least in part on a communication direction of the one or more scheduled resources indicated by the control signaling.

Aspect 4: The method of any of aspects 2 through 3, wherein receiving the control signaling comprises: receiving a field comprising one or more bits, wherein the commencement time is calculated from the ending time of the temporally last resource based at least in part on a value of the one or more bits.

Aspect 5: The method of aspect 4, wherein the field comprises a control channel monitoring duration field, a dedicated field, or both.

Aspect 6: The method of any of aspects 2 through 5, further comprising: calculating the commencement time from the ending time of the temporally last resource by subtracting a quantity of slots from the ending time of the temporally last resource.

Aspect 7: The method of aspect 6, wherein the quantity of slots comprises a minimum scheduling offset associated with the UE.

Aspect 8: The method of aspect 6, wherein the quantity of slots comprises a lesser quantity of slots between a minimum scheduling offset associated with the UE and a constant quantity of slots.

Aspect 9: The method of any of aspects 1 through 8, wherein the control signaling further indicates a first BWP for the one or more shared channel communications, and wherein performing the monitoring operation comprises: switching to a second BWP based at least in part on a BWP switching indication indicated in the control signaling.

Aspect 10: The method of aspect 9, wherein the BWP switching indication comprises a dedicated field of the control signaling comprising one bit, and a value of the one bit indicates that the UE is to switch to the second BWP at the commencement time that is calculated from the ending time.

Aspect 11: The method of any of aspects 9 through 10, wherein the BWP switching indication comprises a first bandwidth indicator field that indicates the first BWP, and a second field indicates the second BWP.

Aspect 12: The method of any of aspects 9 through 11, further comprising: receiving an indication of a timer value, wherein the commencement time is calculated by summing the ending time of the temporally last resource and the timer value.

Aspect 13: The method of aspect 12, wherein performing the one or more shared channel communications comprise transmitting a NACK indication based at least in part on failing to receive a shared channel communication of the one or more shared channel communications, wherein the method further comprises: increasing the timer value based at least in part on failing to receive a retransmission of the shared channel communication in response to the NACK indication prior to the commencement time.

Aspect 14: The method of any of aspects 12 through 13, wherein a field of the control signaling comprises the indication of the timer value.

Aspect 15: The method of any of aspects 12 through 14, wherein receiving the indication of the timer value comprises: receiving RRC signaling comprising the indication of the timer value.

Aspect 16: The method of any of aspects 12 through 15, wherein summing the ending time of the temporally last resource and the timer value is based at least in part on a communication direction of the one or more shared channel communications.

Aspect 17: The method of any of aspects 1 through 8, wherein the control signaling further indicates a first BWP for the one or more shared channel communications, wherein the control signaling indicates to switch to a second BWP at the commencement time, and wherein the commencement time is calculated by summing the ending time of the temporally last resource and a timer value, the method further comprising: receiving second control signaling before the commencement time, wherein performing the monitoring operation comprises: continuing, before switching to the second BWP, shared channel communications within the first BWP for an additional time period after the commencement time.

Aspect 18: A UE for wireless communications, comprising one or more memories storing processor-executable code, and one or more processors coupled with the one or more memories and individually or collectively operable to execute the code to cause the UE to perform a method of any of aspects 1 through 17.

Aspect 19: A UE for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a control channel, control signaling indicating one or more scheduled resources for one or more shared channel communications;
perform the one or more shared channel communications within the one or more scheduled resources in accordance with the control signaling; and
perform a monitoring operation triggered by the control signaling, the monitoring operation starting at a commencement time calculated from an ending time of a temporally last resource of the one or more scheduled resources indicated by the control signaling.

2. The UE of claim 1, wherein, to perform the monitoring operation, the one or more processors are individually or collectively operable to execute the code to cause the UE to:
resume, after one or more skipped control signal monitoring occasions, a monitoring of control signal monitoring occasions on the control channel.

3. The UE of claim 2, wherein the one or more skipped control signal monitoring occasions are determined based at least in part on a communication direction of the one or more scheduled resources indicated by the control signaling.

4. The UE of claim 2, wherein, to receive the control signaling, the one or more processors are individually or collectively operable to execute the code to cause the UE to:
receive a field comprising one or more bits, wherein the commencement time is calculated from the ending time of the temporally last resource based at least in part on a value of the one or more bits.

5. The UE of claim 4, wherein the field comprises a control channel monitoring duration field, a dedicated field, or both.

6. The UE of claim 2, wherein the one or more processors are individually or collectively further operable to execute the code to cause the UE to:
calculate the commencement time from the ending time of the temporally last resource by subtracting a quantity of slots from the ending time of the temporally last resource.

7. The UE of claim 6, wherein the quantity of slots comprises a minimum scheduling offset associated with the UE.

8. The UE of claim 6, wherein the quantity of slots comprises a lesser quantity of slots between a minimum scheduling offset associated with the UE and a constant quantity of slots.

9. The UE of claim 1, wherein the control signaling further indicates a first bandwidth part for the one or more shared channel communications, and wherein, to perform the monitoring operation, the one or more processors are individually or collectively operable to execute the code to cause the UE to:
switch to a second bandwidth part based at least in part on a bandwidth part switching indication indicated in the control signaling.

10. The UE of claim 9, wherein the bandwidth part switching indication comprises a dedicated field of the control signaling comprising one bit, and wherein a value of the one bit indicates that the UE is to switch to the second bandwidth part at the commencement time that is calculated from the ending time.

11. The UE of claim 9, wherein the bandwidth part switching indication comprises a first bandwidth indicator field that indicates the first bandwidth part, and a second field indicates the second bandwidth part.

12. The UE of claim 9, wherein the one or more processors are individually or collectively further operable to execute the code to cause the UE to:
receive an indication of a timer value, wherein the commencement time is calculated by summing the ending time of the temporally last resource and the timer value.

13. The UE of claim 12, wherein, to perform the one or more shared channel communications, the one or more processors are individually or collectively operable to execute the code to cause the UE to:
transmit a negative acknowledgement indication based at least in part on failing to receive a shared channel communication of the one or more shared channel communications, wherein the one or more processors are individually or collectively further operable to execute the code to cause the UE to:
increase the timer value based at least in part on failing to receive a retransmission of the shared channel communication in response to the negative acknowledgement indication prior to the commencement time.

14. The UE of claim 12, wherein a field of the control signaling comprises the indication of the timer value.

15. The UE of claim 12, wherein, to receive the indication of the timer value, the one or more processors are individually or collectively operable to execute the code to cause the UE to:
receive radio resource control signaling comprising the indication of the timer value.

16. The UE of claim 12, wherein summing the ending time of the temporally last resource and the timer value is based at least in part on a communication direction of the one or more shared channel communications.

17. The UE of claim 1, wherein the control signaling further indicates a first bandwidth part for the one or more shared channel communications, wherein the control signaling indicates to switch to a second bandwidth part at the commencement time, wherein the commencement time is calculated by summing the ending time of the temporally last resource and a timer value, and wherein the one or more processors are individually or collectively further operable to execute the code to cause the UE to:
receive second control signaling before the commencement time, wherein, to perform the monitoring operation, the one or more processors are individually or collectively operable to execute the code to cause the UE to:
continue, before switching to the second bandwidth part, shared channel communications within the first bandwidth part for an additional time period after the commencement time.

18. A method for wireless communications at a user equipment (UE), comprising:
receiving, via a control channel, control signaling indicating one or more scheduled resources for one or more shared channel communications;
performing the one or more shared channel communications within the one or more scheduled resources in accordance with the control signaling; and
performing a monitoring operation triggered by the control signaling, the monitoring operation starting at a commencement time calculated from an ending time of a temporally last resource of the one or more scheduled resources indicated by the control signaling.

19. The method of claim 18, wherein performing the monitoring operation comprises:
resuming, after one or more skipped control signal monitoring occasions, a monitoring of control signal monitoring occasions on the control channel.

20. The method of claim 19, wherein the one or more skipped control signal monitoring occasions are determined based at least in part on a communication direction of the one or more scheduled resources indicated by the control signaling.

21. The method of claim 19, wherein receiving the control signaling comprises:
receiving a field comprising one or more bits, wherein the commencement time is calculated from the ending time of the temporally last resource based at least in part on a value of the one or more bits.

22. The method of claim 21, wherein the field comprises a control channel monitoring duration field, a dedicated field, or both.

23. The method of claim 19, further comprising:
calculating the commencement time from the ending time of the temporally last resource by subtracting a quantity of slots from the ending time of the temporally last resource.

24. The method of claim 23, wherein the quantity of slots comprises a minimum scheduling offset associated with the UE.

25. The method of claim 23, wherein the quantity of slots comprises a lesser quantity of slots between a minimum scheduling offset associated with the UE and a constant quantity of slots.

26. The method of claim 18, wherein the control signaling further indicates a first bandwidth part for the one or more shared channel communications, and wherein performing the monitoring operation comprises:
switching to a second bandwidth part based at least in part on a bandwidth part switching indication indicated in the control signaling.

27. The method of claim 26, wherein the bandwidth part switching indication comprises a dedicated field of the control signaling comprising one bit, and wherein a value of the one bit indicates that the UE is to switch to the second bandwidth part at the commencement time that is calculated from the ending time.

28. The method of claim 26, wherein the bandwidth part switching indication comprises a first bandwidth indicator field that indicates the first bandwidth part, and a second field indicates the second bandwidth part.

29. A non-transitory computer-readable medium storing code for wireless communications, the code comprising instructions executable by one or more processors to:
receive, via a control channel, control signaling indicating one or more scheduled resources for one or more shared channel communications;
perform the one or more shared channel communications within the one or more scheduled resources in accordance with the control signaling; and
perform a monitoring operation triggered by the control signaling, the monitoring operation starting at a commencement time calculated from an ending time of a temporally last resource of the one or more scheduled resources indicated by the control signaling.

30. A user equipment (UE) for wireless communications, comprising:
means for receiving, via a control channel, control signaling indicating one or more scheduled resources for one or more shared channel communications;
means for performing the one or more shared channel communications within the one or more scheduled resources in accordance with the control signaling; and
means for performing a monitoring operation triggered by the control signaling, the monitoring operation starting at a commencement time calculated from an ending time of a temporally last resource of the one or more scheduled resources indicated by the control signaling.
